(19) United States
(12) Patent Application Publication
(10) Pub. No.: US 2008/0086366 A1
(43) Pub. Date: Apr. 10, 2008

(54) Method For Interactive Employment Searching And Skills Specification

(76) Inventors: David Joseph Concordia, Worcester, MA (US); Daniel Scott DeMaioNewton, Northborough, MA (US); William M. Bradbury, Nashua, NH (US); Sundaresan Lakshminarayana, Woburn, MA (US); Gregory F. Valeri, Haverhill, MA (US); Ruchi Saggar, Cambridge, MA (US)

Correspondence Address: CHADBOURNE & PARKE LLP, 30 ROCKEFELER PLAZA, NEW YORK, NY, 10112, US

(21) Appl. No.: 11/615,768

(22) Filed: Dec. 22, 2006

Related U.S. Application Data
(60) Provisional application No. 60/825,711, filed on Sep. 14, 2006.
(60) Provisional application No. 60/862,022, filed on Oct. 18, 2006.

(51) Int. Cl. H04M 3/51

(52) U.S. Cl. 705/11

(57) ABSTRACT

The present disclosure details apparatuses, systems and methods for an Interactive Employment Search Platform enabling interactive employment searching and skills specification. The Platform enables employers and job seekers to easily identify, connect, and coordinate with one another. The disclosed systems and methods collect profile data for jobs, employers, and job seekers. This profile data includes a specification of skill levels either possessed or desired, in the case of job seekers, or required/recommended, in the case of job listings. Skill sets may then be compared to determine the congruency between job listings and job seekers, as well as to supply information about skill deficiencies. Additionally, the Platform generates extended job seeker profiles containing job listing ratings that enable future job listing searches with highly tailored specificity. By connecting job seekers with the employment opportunities most closely associated with their skills and interests, the Platform effectively increases the efficiency and success potential of hiring efforts.

This disclosure claims priority to U.S. Patent Application No. 60/825,711 entitled, “APPARATUSES, METHODS AND SYSTEMS FOR AN INTERACTIVE EMPLOYMENT SEARCH PLATFORM,” filed on Sep. 14, 2006, which is hereby incorporated by reference.

### FIELD

The present invention is generally directed to apparatuses, methods and systems for employment searching, and more particularly, to apparatuses, methods and systems for entering employment profile and skills information.

### BACKGROUND

Many employment opportunities exist in the labor market and new ones become available on a daily basis. At the same time, there are many people seeking employment. Matching job seekers to suitable employment opportunities requires handling a large volume and variety of job requirements and seeker experience levels. Job seekers identify potential opportunities directly through employer listings or via passive job search engines.

### SUMMARY

This disclosure details the implementation of the apparatuses, methods, and systems for an Interactive Employment Search Platform (hereafter “Platform”) enabling interactive employment searching and skills specification. The Platform empowers employers and job seekers to easily identify, connect, and coordinate with one another. Current methods provide only limited and passive employment search capabilities, and significant additional effort is required for job seekers to identify the best opportunities. This frustrates the efficiency of job placement efforts from both employer and job seeker perspectives. In one embodiment, the Platform allows job seekers to specify skills that they possess and allows employers to specify skills that they deem desirable for a particular job opening, and then matches job seekers with the most suitable openings based on these specified skill sets. This streamlines the job search process, increases the satisfaction level of both employers and job seekers, and benefits the labor market as a whole. Furthermore, the Platform can use skill sets to match job seekers with openings that they may not have considered available to them, and it can provide an analysis of skill deficiencies to job seekers to help them identify areas where they may need improvement in order to be hired for a desired job.

### BRIEF DESCRIPTION OF THE DRAWINGS

The accompanying appendices and/or drawings illustrate various non-limiting, representative, inventive aspects in accordance with the present disclosure:

FIG. 1 illustrates the logic flow for one embodiment of the Flash Search module;

FIGS. 2A and 2B illustrate the logic flow for two embodiments of the Create Account module;

FIG. 3 illustrates the logic flow for one embodiment of the Job Select module;

FIG. 4 illustrates the logic flow for one embodiment of the Skills Select module;

FIG. 5 illustrates an embodiment of the Skills Select module user interface;

FIG. 6 illustrates a second embodiment of the Skills Select module user interface;

FIG. 7 illustrates an embodiment of the Skills Match module in a two-dimensional skill space;

FIG. 8 illustrates another embodiment of the Skills Match module in a two-dimensional skill space;

FIG. 9 illustrates an embodiment of the Skills Deficiency module in a two-dimensional skill space;

FIG. 10 illustrates a systemization diagram for an embodiment of the Interactive Employment Search Platform;

Appendix 1 contains embodiments of XML data structures useful for converting job titles into occupational classification codes.

### DETAILED DESCRIPTION

In one embodiment, the Platform employs three basic actors: (i) a Job Seeker, that is any individual or group seeking job listings or activity information using the Platform, including but not limited to people seeking employment for themselves or others, employment agencies, “headhunters”, human resources personnel, activity participants, and/or the like; (ii) an Employer, that is any individual or group providing job listings or activity information to the Platform, including but not limited to individuals, companies, businesses, universities, non-profit organizations, government agencies, recruiters, employment agencies, human resources personnel, activity organizers, and/or the like; and (iii) a Server capable of storing and analyzing information transmitted to and from Job Seekers and Employers. Though terms such as Job Seeker, Employer, job listing, job title, company, etc. will be utilized, they are intended to be non-limiting and should be understood to encompass all manner of activity participants, providers, information, and identifiers.

In one embodiment, the Platform acts as a conduit for connecting Job Seekers with job listings supplied by Employers. In that capacity, the Platform accepts information from Job Seekers to match them with suitable job listings. It also allows for user feedback regarding the suitability of job listings supplied by the Platform, which refines future search strategies. In another embodiment, the Platform facilitates the specification of skill sets associated with individuals, groups, organizations, job titles, job listings, companies, and/or the like and the automatic comparison of those sets.

Implementations of these embodiments, including the modules employed by the Platform, are described below:
Flash Search Module

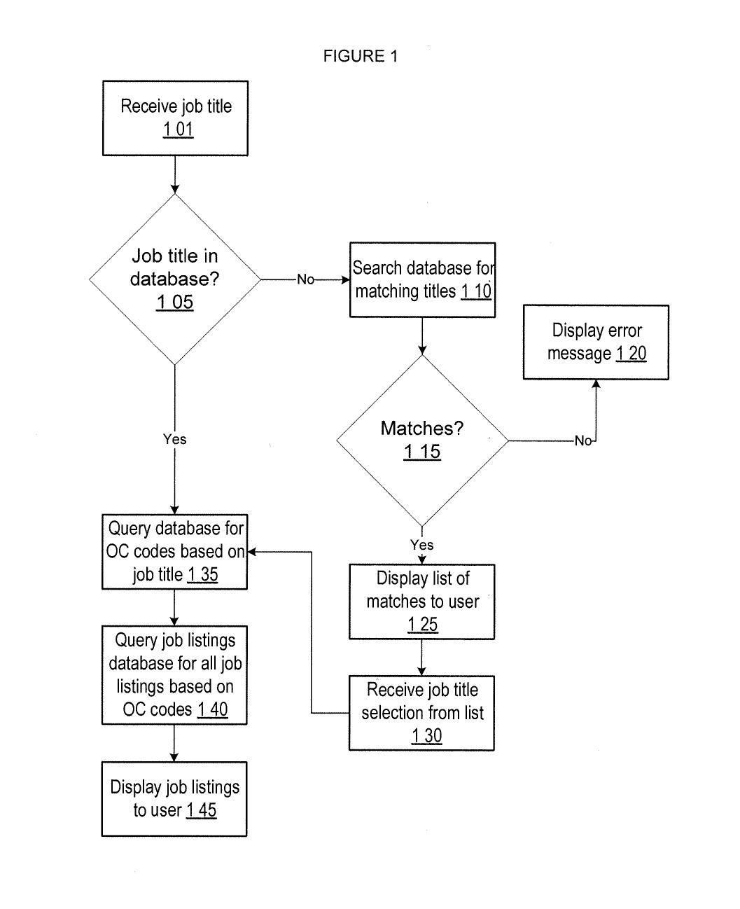

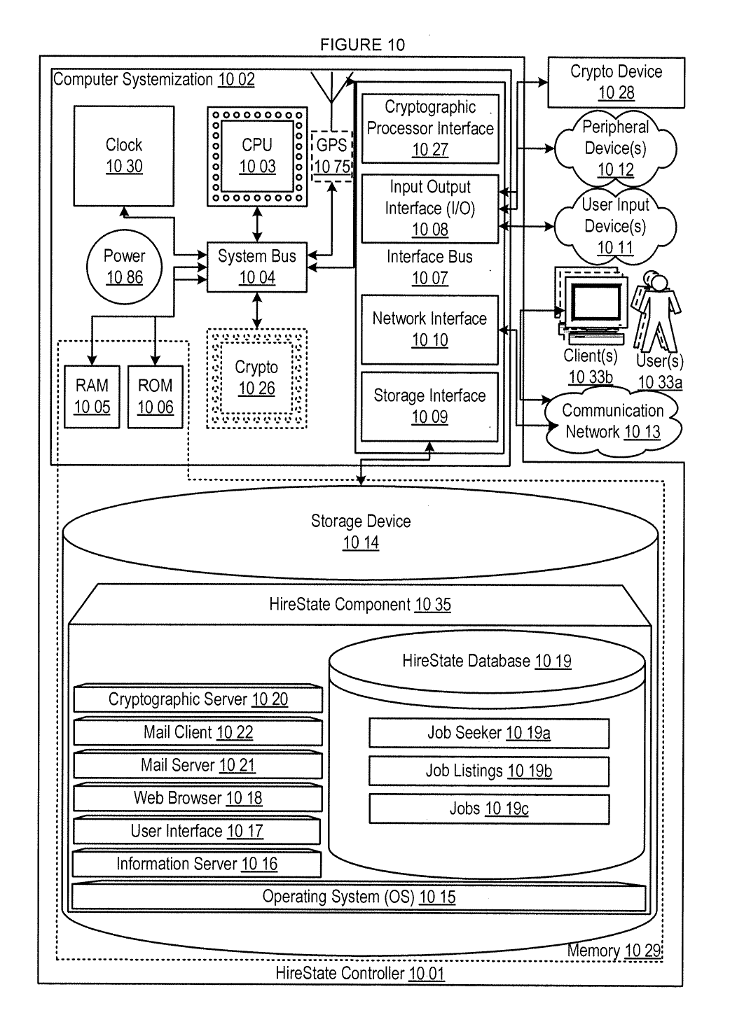

In one embodiment, the Flash Search module allows a Job Seeker to enter personal information, such as a job title, and receive a set of job listings in response. In one embodiment, this is based on classifications of the job title compared to classifications of all jobs to be searched upon. An embodiment of the logic flow within the Flash Search module is exhibited in FIG. 1. In this embodiment, the Platform receives a target job title 101, such as from a Job Seeker. The entry of a job title may be accomplished in a number of ways depending on the specific requirements of the implemented embodiment. In one embodiment, the Job Seeker may select his or her job title from a pre-defined list of job titles, such as by clicking on a job title in a drop-down menu. In an another embodiment, the Job Seeker may be presented with a series of drop-menus containing various job categories, from which he or she may select relevant categories to narrow down the field of possible job titles and eventually yield the job title appropriate to him or her (e.g., Life, Physical, and Social Sciences→Physical Sciences→Physicist). In the embodiment of the figure, the Job Seeker may enter his or her job title directly, such as by typing it into a text box. A Jobs database (see element 1019c of FIG. 10) of qualified job titles may then be queried based on the entered title 105. If no exact matches are found, then the Jobs database may be searched to find job titles with elements matching elements of the entered job title 110. For example, if a Job Seeker enters the job title “analyst”, the Platform may search for all job titles in the database containing the word “analyst” and present them to the Job Seeker, who may then select the specific qualified job title most relevant to him or her (e.g., “software analyst). The platform determines whether there are any matches between job title elements 115 and, if no matches are found, an error message is presented to the user 120. If, on the other hand, job titles are found that possess matching elements to elements of the entered job title, then these titles may be displayed to the user 125 who may then select the appropriate title or titles from the displayed list. The selected title is received by the Platform 130, and converted into an occupational classification (OC) code, such as an Occupational Information Network (O*Net) Standard Occupational Classification (SOC) code. Such a conversion may be accomplished by querying a Jobs database based on the job title 135. Qualified job titles may exist in a Jobs database data structure with a uniquely defined set of OC codes, and the entry of one of these titles triggers a Jobs database search that queries and returns the corresponding codes. In an alternative embodiment, the narrow of jobs performed at 125 and 130 may be bypassed, and all OC codes associated with the job titles passed at 115 may be queried and returned. The returned OC codes are then used to extract job listings that have the same or similar OC codes from a Job Listings database 140 (see element 1019b of FIG. 10) for display to the Job Seeker 145. Job titles (and the corresponding job listings) and OC codes are associated via data structures in the Job Listings database, so the Job Listings database may be searched based on the OC codes to return all job listings associated with a given OC code. In another embodiment, the Flash Search module considers a Job Seeker's most recent job title, while in another embodiment the Flash Search module considers any previous Job Seeker job title. In one embodiment, the Job Seeker manually enters a job title into the Flash Search module, while in another embodiment the Flash Search module automatically receives a job title from another Platform module, while in yet another embodiment the Flash Search module itself extracts a job title from a set of Job Seeker profile information, for example, by extracting keywords from a resume or job listing description using an existing software-implemented keyword extraction algorithm such as Teragram Enterprise KnowledgeBase Extraction Enhancers.
Job Title Conversion

An embodiment of the procedure to convert a job title to an associated OC code or codes was hinted at in the description of the Flash Search module given above. There are a variety of fields and factors that may be queried or returned when searching the Jobs database for a matching or qualified job title or OC code. In one embodiment, an XML job title query takes the following form:

```
<Job_Title_Query_Packet>
      <language> English </language>
      <incldudeMatchPosition> true </incldudeMatchPosition>
      <incldudeWeights> true </incldudeWeights>
      <incldudeJobCategory> true </incldudeJobCategory>
      <title> Principal Software Engineer </title>
      <body> </body>
</Job_Title_Query_Packet>
```

Here, the language field indicates the language in which the request is made. The includeMatchPosition, includeWeights, and includeJobCategory fields are Boolean fields that specify the details to be included in the response packet (position of the title query matched in the database, weight of the match for a matching database entry, and associated job category respectively). Finally, the title field contains the job title to be searched and the body field (empty here) may contain any other search terms, such as keywords or the content of a resume. The XML response to such a query from the Jobs database may take the following form in one embodiment:

```
< Response_Packet>
      <title_match>
              <OC_code> 101395 </OC_code>
              <MatchPositions>
                    <string> 0-16 </string>
              </MatchPositions>
              <Weight> 1.0 </Weight>
              <JobCategory> Computer and Mathematical
              </JobCategory>
      </title_match>
      <body_match> </body_match>
</Response_Packet>
```

Here, the title_match field contains results of the search based on the job title. Only one match is shown in the example, but additional matches may also be included in the response packet. Similarly, the body_match field (empty here) contains one or more search results from the Jobs database based on the body field of the database query. In addition to the MatchPositions, Weight, and JobCategory fields (the purposes of which were described in the context of the query packet with corresponding Boolean fields), there is an OC_code field that contains the OC code corresponding to the job title in the Jobs database. Additional embodiments of the above XML data structures are provided in Appendix 1.
Create Account Module

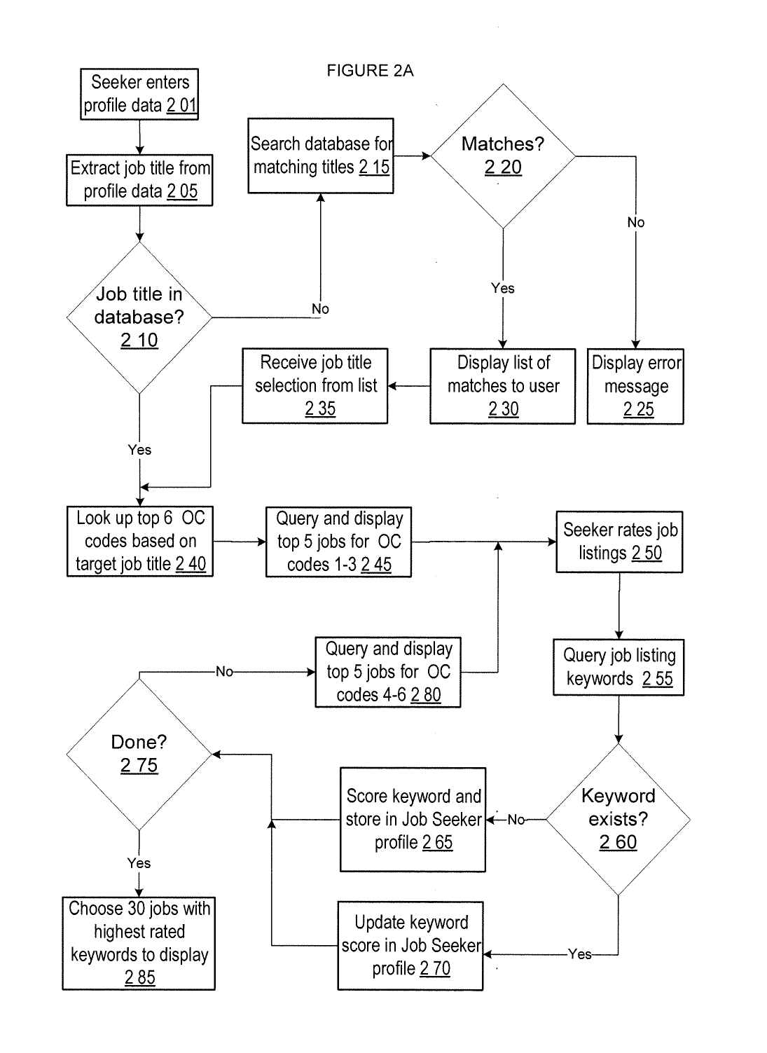

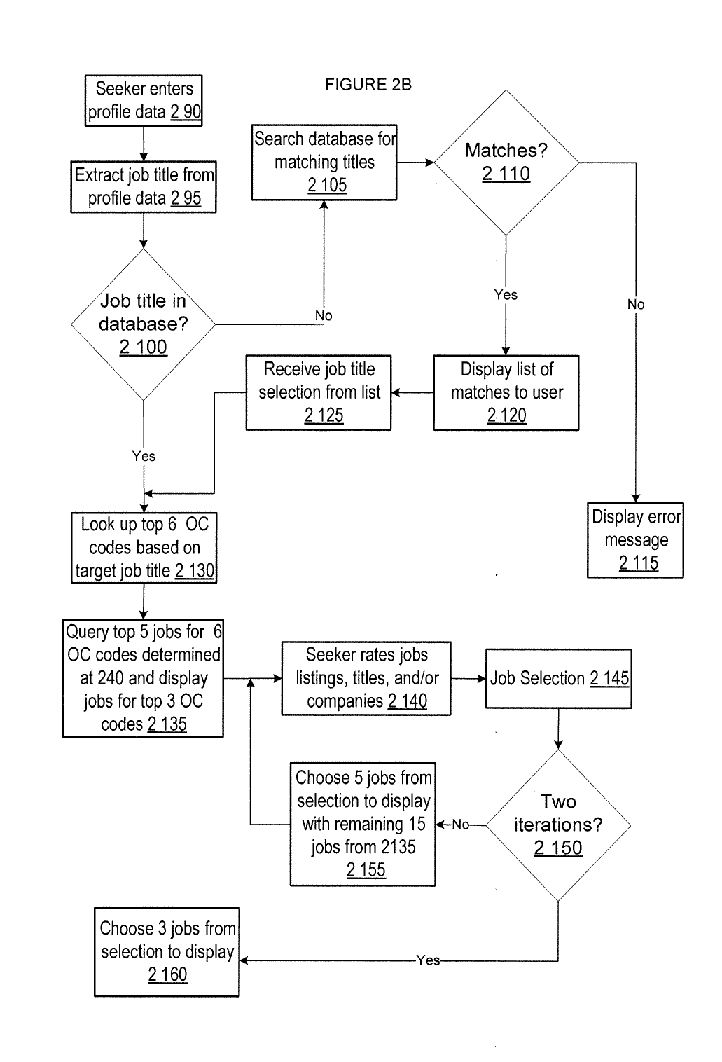

In one embodiment, to personalize the job search experience, a Job Seeker may elect to create a personalized account within the Platform. This is accomplished by the Create Account module, for which embodiments of the logic flow are exhibited in FIGS. 2A and 2B. In the embodiment shown in FIG. 2A, a Job Seeker enters personal information such as profile data and/or a resume at 201. This information may be stored as a Job Seeker profile in a Job Seeker database (see element 1019a of FIG. 10). In one embodiment, the Platform automatically extracts a target job title from the profile data and/or resume 205, for example, by extracting keywords from the job listing description using an existing software-implemented keyword extraction algorithm such as Teragram Enterprise KnowledgeBase Extraction Enhancers. In an alternative embodiment, the Job Seeker manually enters his or her target job title. In another embodiment, a most-recent job title is employed, while in another embodiment, any previous job title is employed. The Platform determines whether the extracted or entered job title has an exact match in the Jobs database at 210 and, if not, then elements of the entered job title are used to search the Jobs database for job titles with matching elements 215. For example, an entered job title of “technology consultant” may yield a search of the database for all job titles containing either the term “technology” and/or the term “consultant”. If there are no matches for the elements of the entered job title 220, an error message is returned to the Job Seeker 225. Otherwise, the list of matching job titles is presented to the Job Seeker 230, and he or she may select the desired title or titles to be received 235 by the Platform for further processing. The Platform queries a plurality of OC codes associated with the target job title 240 by searching through a database containing data structures possessing job titles and associated OC codes. In one embodiment, 6 OC codes are selected at 240. In one embodiment, the OC codes associated with a given job title may be ranked based on closeness or relevance, and only a subset of most-closely associated OC codes may be queried. Based on the OC codes, a plurality of job listings are queried from the Job Listings database and displayed to the Job Seeker 245 based on a subset of the OC codes. In one embodiment, the top 3 OC codes from 240 are selected at 245. In one embodiment, this subset is chosen based on OC codes having the highest rankings. At 250, the Job Seeker rates these listings. Based on these ratings, the Platform queries a selection of keywords associated with the job listing 255 and checks the stored Job Seeker profile information 260 to determine whether the keywords have been previously rated. If the keyword has not been rated previously, it is appended to the Job Seeker profile with the associated score based on the Job Seeker's rating of the job listing 265. Otherwise, the keyword score in the Job Seeker profile is modified and/or updated based on the new job listing rating 270. Details surrounding ratings of job listings and job listing fields are provided in the co-pending application entitled “A Method For Interactive Searching, Rating, and Selecting of Employment Listings”, which is incorporated in its entirety herein by reference. If all of the OC codes from 240 have not been rated 275, then the module proceeds to 280 where the remaining OC codes are queried and displayed for rating to the Job Seeker. Otherwise, 30 job listings having the highest rated keywords are selected from the job listing database for display to the user at 275.

In the embodiment shown in FIG. 2B, a Job Seeker enters personal information such as profile data and/or a resume at 290. This information may be stored as a Job Seeker profile in a Job Seeker database (see element 1019a of FIG. 10). In one embodiment, the Platform automatically extracts a target job title from the profile data and/or resume 295, for example, by extracting keywords from the job listing description using an existing software-implemented keyword extraction algorithm such as Teragram Enterprise KnowledgeBase Extraction Enhancers. In an alternative embodiment, the Job Seeker manually enters his or her target job title. In another embodiment, a most-recent job title is employed, while in another embodiment, any previous job title is employed. The Platform determines whether the extracted or entered job title has an exact match in the Jobs database at 2100 and, if not, then elements of the entered job title are used to search the Jobs database for job titles with matching elements 2105. If there are no matches for the elements of the entered job title 2110, an error message is returned to the Job Seeker 2115. Otherwise, the list of matching job titles is presented to the Job Seeker 2120, and he or she may select the desired title or titles to be received 2125 by the Platform for further processing. The Platform queries a plurality of OC codes associated with the target job title 2130 by searching through a database containing data structures possessing job titles and associated OC codes. In one embodiment, the OC codes associated with a given job title may be ranked based on closeness or relevance, and only a subset of most-closely associated OC codes may be queried. Based on the OC codes, a plurality of job listings are queried from the Job Listings database and displayed to the Job Seeker 2135. In one embodiment, a subset of the OC codes having the highest rankings are used to select a plurality of job listings for display to the Job Seeker. At 2140, the Job Seeker rates these listings, as well as the associated job titles and companies. In one embodiment, the rating of job titles and companies is optional. In another embodiment, other job listing fields may be rated such as keywords, job categories, locations, salary/wage, benefits, vacation time, and/or the like. Based on these ratings, the Job Select module 2145 (described below) selects a second plurality of job listings. If the rating and job selection loop has only been traversed once 2150, then the selection of jobs from 2145, along with the remaining listings from 2135, are displayed to the Job Seeker 2155 who again rates these job listings, job titles, and companies. The Job Select module selects a set of job listings from the job listing database according to the Job Seeker ratings. After two iterations 2150, the Create Account module selects a plurality of job listings from the listings generated by the Job Select module and displays them to the Job Seeker 2160.
Job Select Module

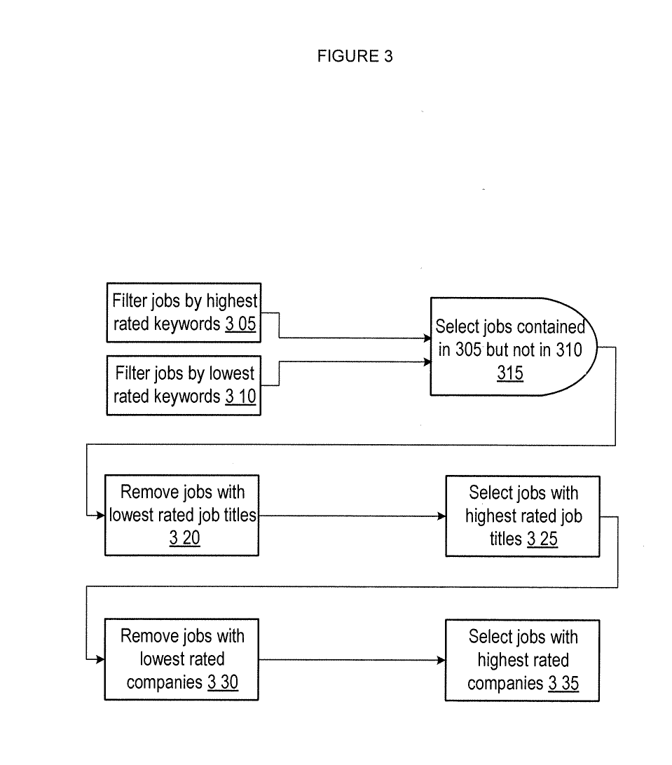

In one embodiment, the Job Select module queries and selects job listings from a job listings database based on Job Seeker responses. An embodiment of the logic flow within the Job Seeker module is exhibited in FIG. 3. In this embodiment, the Job Seeker has rated keywords, titles, and companies associated with a plurality of job listings. Based on these ratings, the Job Seeker module progressively filters elements of the job listing database to extract job listings most suited to the Job Seeker. At 305, the module selects listings containing the highest rated keywords while, at 310, the module selects listings containing the lowest rated keywords. At 315, the module selects the set of jobs selected in 305 that are not also in the set selected at 310. The module removes job listings from the remaining set that possess the lowest rated job titles 320 and selects the set of listings from the remaining set that have the highest rated job titles 325. The module removes job listings from the remaining set that possess the lowest rated companies 330 and selects the set of listings from the remaining set that have the highest rated companies 335. In another embodiment, the Job Select module may consider only keywords, job titles, or companies in filtering. In another embodiment, the Job Select module may consider other rated elements in filtering, such as job categories, location, salary/wage, benefits, vacation time, and/or the like.
Skills Select Module

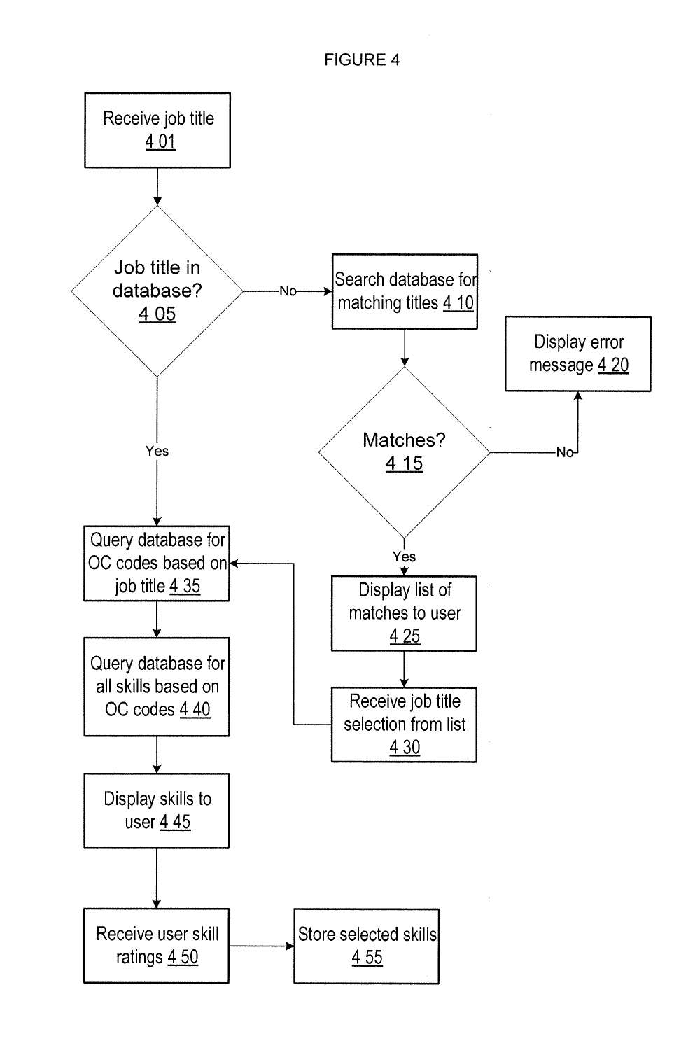

In one embodiment, the Platform further allows both Job Seekers and Employers to specify a plurality of skills and/or abilities that may be associated with a Job Seeker(s), job title(s), company or companies, job listing(s), and/or the like. An embodiment of the logic flow within the Skills Select module is exhibited in FIG. 4. For a given job title entered by a user 401, the Skills Select module searches a Jobs database to determine if there exists an exactly matching job title 405. If not, then elements of the entered job title are used to search the Jobs database job titles with matching elements 410. The existence of matches is assessed 415 and, if there are no matches, an error message is displayed to the user 420. Otherwise, a list of job titles with matching elements may be displayed to the user 425 who may then select the job title or titles from that list having greatest relevance 430. The Jobs database is then queried using the resulting job title or titles to find associated OC codes 435. In an alternative embodiment, the job title is converted into OC codes by a separate Platform module. Skills associated with each OC code, such as those associated with O*Net SOC codes, may exist in data structures along with their associated OC codes and may be queried from the Jobs database 440 and displayed to the user 445. This may be a table of skills and weights keyed by code. In one embodiment, the user may select a subset of skills from the original set, for example by clicking a check box next to each selected skill. In an alternative embodiment, the user may rate each of the displayed skills as to how much it applies to them or to the particular job listing 450. The selected skills, or skill ratings, are then stored in association with a Job Seeker profile or job listing 455.

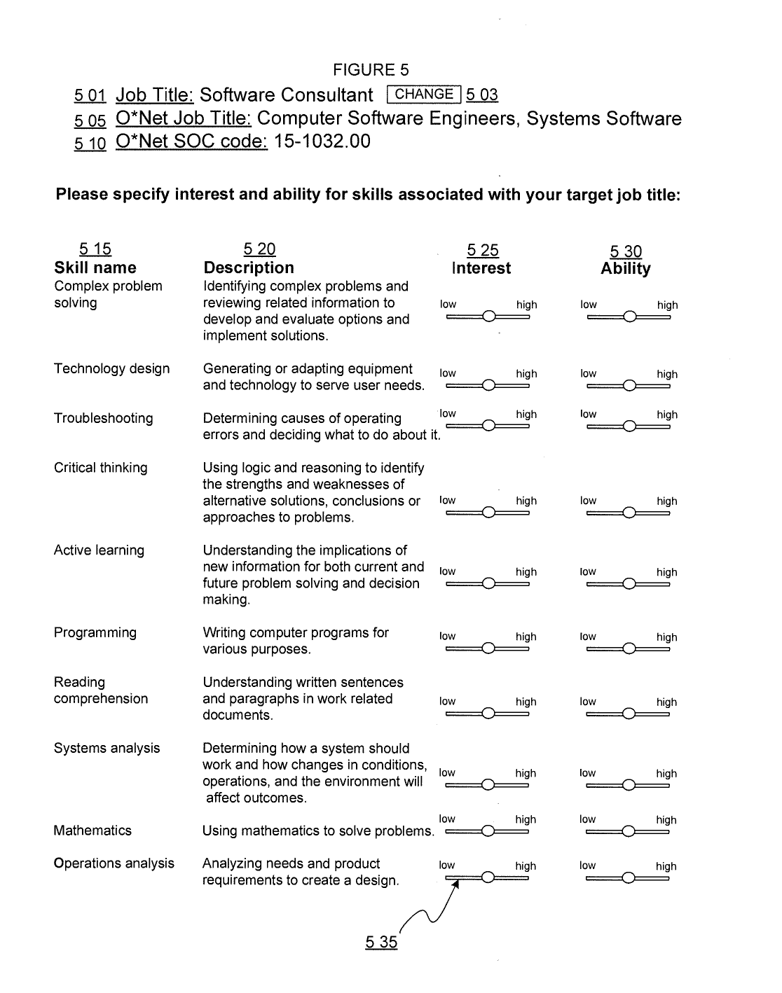

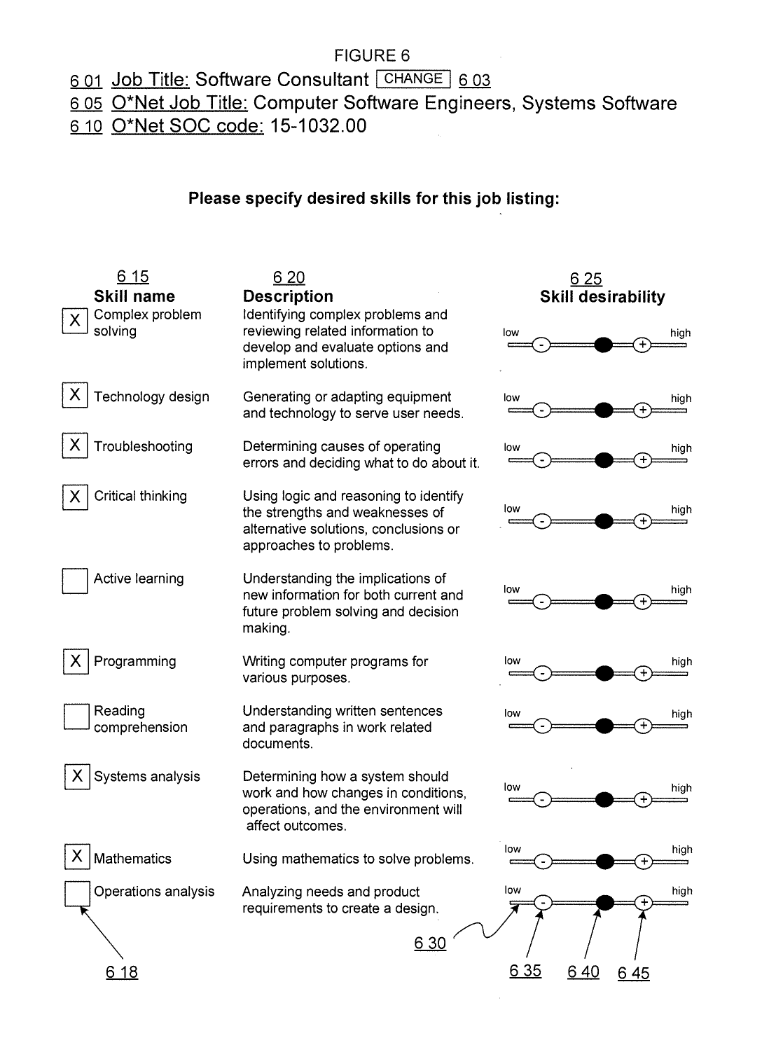

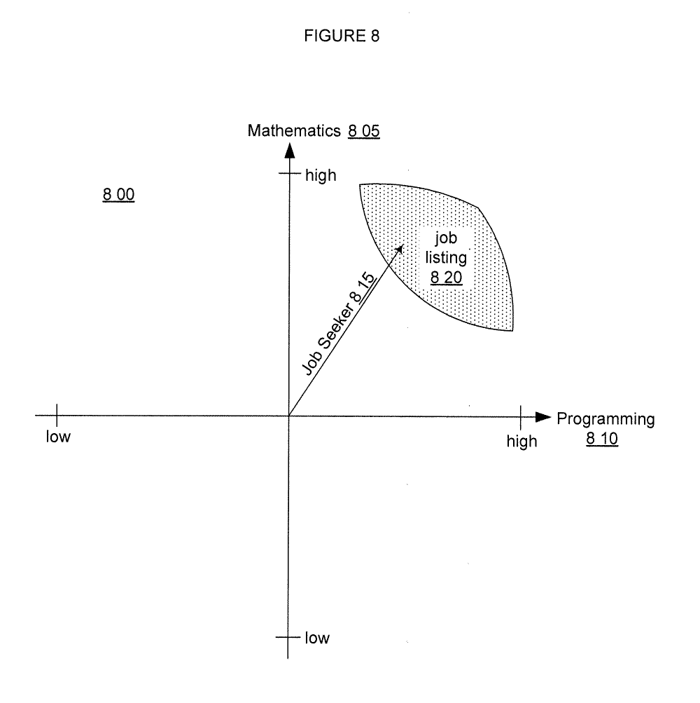

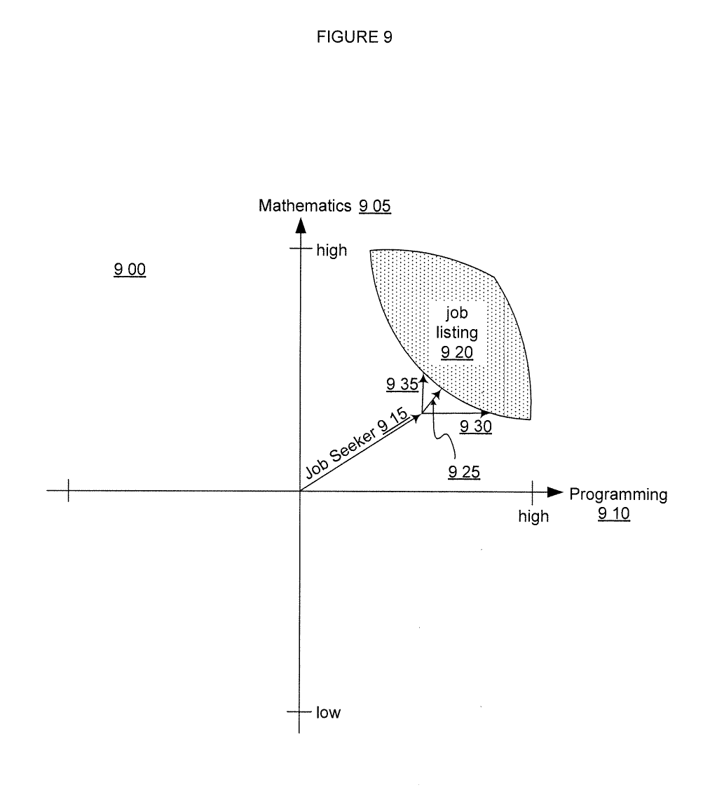

To further elucidate the Skills Select module, embodiments of user interfaces (UIs) are exhibited for Job Seeker (FIG. 5) and Employer (FIG. 6) skills selection. In FIG. 5, the Job Seeker has entered a target job title of “Software Consultant” 501, which the Skills Select module has converted into an equivalent or closely associated O*Net job title (“Computer Software Engineers, Systems Software”) 505 and O*Net SOC code (15-1032.00) 510. There is also a button to change the target job title 503. Associated with the job title are a list of skills 515 that are displayed to the Job Seeker along with descriptions 520. In this embodiment, the Job Seeker may rate his or her interest 525 and ability 530 in each skill using a slider widget 535. This will set a text box value and may be used as criteria for matches. In an alternative embodiment, the Job Seeker may be allowed to specify ranges of skill levels that apply to them. In yet another embodiment, the Job Seeker may be allowed to specify a job skill subspace of arbitrary shape within which their skill levels fall (see, e.g., job listings subspace in FIGS. 8-9). Such a subspace could be specified via multivariable functions or graphically, by drawing curves and shapes in a multidimensional “skill space” graphical user interface (GUI).

In FIG. 6, the Employer has entered a job title of “Software Consultant” 601 associated with a job listing, which the Skill Select module has converted into an equivalent or closely associated O*Net job title (“Computer Software Engineers, Systems Software”) 605 and O*Net SOC code (15-1032.00) 610. There is also a button to change the target job title 603. Associated with the job title are a list of skills 615 that are displayed to the Employer along with descriptions 620. In this embodiment, the Employer may select the skills deemed to be relevant to the job listing by clicking a check-box widget 618. The Employer may further rate the desirability or necessity of a particular skill 625 for the job listing using a slider widget 630. In this embodiment, the Employer may specify ranges of skills that are appropriate for a particular job listing using the (−) 635 and (+) 645 sliders, and may specify an ideal or optimal skill level using the black slider 640. The (−) slider may specify the minimum level of skill required for the job, while the (+) slider may specify the cutoff for a Job Seeker being “overqualified” for the job. In another embodiment, the Employer may specify relationships between different skills associated with a particular job listing. For example, the Employer may be willing to overlook a lower programming skill if the complex problem solving skill level is particularly high, or vice versa. Such relationships may be specified via multivariable functions or graphically, by drawing curves and shapes in a multidimensional “skill space” graphical user interface (GUI).

Though the UIs presented in FIGS. 5 and 6 employ slider widgets to allow Job Seekers and Employers to rate skills, a variety of alternative interface elements may be employed in this capacity. These include, but are not limited to, checkboxes, buttons, lists, radio buttons, scrollbars, fields, text boxes, menus, icons, and/or the like.

Additional skill rating queries may be employed besides those shown in the embodiments of FIGS. 5 and 6. For example, a Job Seeker may be shown skills associated with their most recent job title(s); their target job title(s); a group of job titles associated with a particular keyword, company, location, etc.; a list of skills relevant to a particular field; a general list of skills; and/or the like. The Job Seeker may then be asked to select or rate which skills they'd like to use in a job, to avoid using, to acquire or improve, and/or the like. An Employer may be shown skills associated with a job listing job title; job titles from a collection of listings associated with a particular keyword, company, location, etc.; and/or the like. The Employer may then be asked to select or rate which skills are required for the job, desirable for the job, undesirable for the job, acquirable or improvable within a job, and/or the like.
Skills Match Module

The skill sets generated for Job Seeker and job listing by the Skill Selection module may be compared by the Skills Match module to determine the suitability of a job listing for a particular Job Seeker. For example, in an embodiment wherein the skills selection is binary (i.e., skill is either selected or not selected), the Skills Match module may calculate a Skills Match metric based on the percentage of common skills between the Job Seeker and job listing.

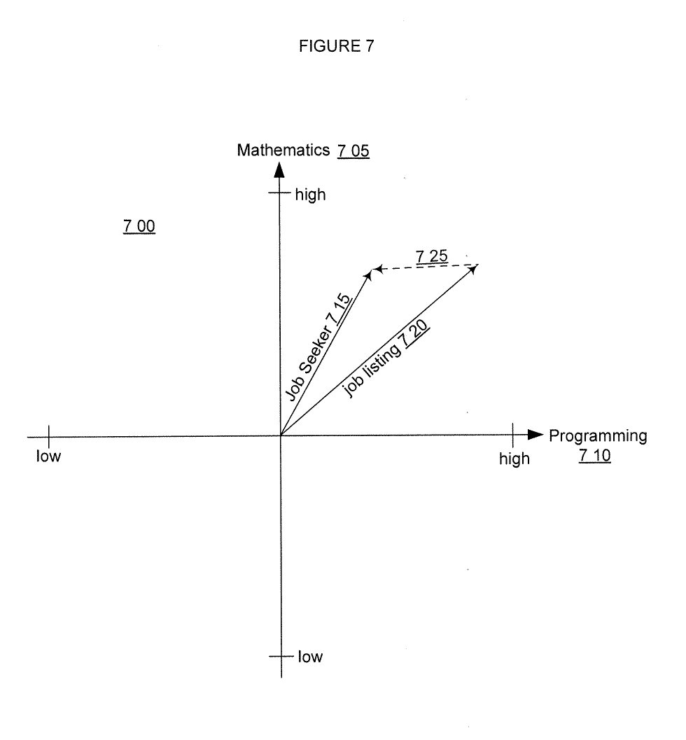

In an alternative embodiment where the skills selection is continuous (e.g., based on slider widgets as in FIGS. 5 and 6), a more elaborate Skills Match metric may be developed to compare skills between a Job Seeker and job listing. In this case, rather than a skill set, the Job Seeker and job listing will have associated skill vectors that specify a coordinate in the multidimensional “skill space” spanned by a basis of skills. An illustration of this embodiment is provided in FIG. 7, wherein the basis comprised of Mathematics 705 and Programming 710 skills spans a skill space 700 populated by a Job Seeker vector 715 and a job listing vector 720. In one embodiment, the Skills Match module may calculate a difference vector Δ that is the difference between the Job Seeker and job listing vectors. The components of Δ are simply the differences between the Job Seeker skill level and job listing skill level for each skill. A modulus (i.e., length) of Δ, then, may comprise the Skills Match metric, quantifying the deviation between the Job Seeker and job listing skills. This particular metric treats under-qualification and over-qualification on an equal footing. If an Employer would prefer over-qualification to under-qualification, as is usually the case, an alternative embodiment of the Skills Match metric may be employed, such as summing the components of the Δ vector. Over-qualifications would register a positive contribution while under-qualifications would register a negative contribution. In this case, the more positive the value of the metric, the better qualified the Job Seeker is for the job listing. In an alternative embodiment of the Skills Match metric, only the under-qualification (i.e., negative) components of Δ may be considered in calculating its modulus.

In an alternative embodiment, wherein the Employer's skills selection for a particular job listing is comprised of a relationship between skills or a range of skill levels (as in FIG. 6), the Skills Match module may simply determine whether the Job Seeker skill vector falls within the region of acceptable skill levels for the job listing. This embodiment is illustrated in FIG. 8, where the same skill space 800 as in FIG. 7 is employed. Here, however, instead of a job listing skill vector, there is a job listing skill subspace 820. If the Job Seeker skill vector 815 falls within the job listing skill subspace 820, the Job Seeker is considered properly qualified for the job in the job listing. This embodiment is well-suited to allow some over-qualification but restrict too much over-qualification. If the Employer had specified acceptable skill ranges for the job listing, the job listing supspace would be an N-dimensional hypercube, where N is the number of skills associated with the job listing's job title. The job listing subspace can take more general shapes if the Employer specifies functional relationships between the skill components or draws the skill subspace directly in a Skill Selection module GUI.

In yet another embodiment, wherein both Job Seeker and job listing skill sets are specified by ranges, a gap analysis may be performed on each skill contained in both sets to determine whether there is an overlap between the range specified for each skill by the Job Seeker and by the Employer for the job listing. In one embodiment, overlapping skills ranges may register as “true” while non-overlapping skill ranges and skills not contained in both skill sets may register as “false”, and the Skills Match metric may, for example, be computed as the ratio of true to false skill matches.
Skills Deficiency Module

In contrast with the Skills Match module that calculates a Skills Match metric, the Skills Deficiency module determines where the Job Seeker's skills are lacking in comparison to a particular job listing. This may be accomplished in a number of ways depending on the way skills are specified in the Skills Selection module. This module may also display the lacked skills to the Job Seeker and make suggestions as to how those skills may be acquired. In one embodiment, direct links and/or information are provided to training and/or educational resources designed or intended to assist the Job Seeker in acquiring the deficient skills.

In one embodiment, wherein the skill selection is binary (i.e., skill is either selected or not selected), the Skills Deficiency module selects those skills contained in the job listing skill set but not in the Job Seeker skill set and displays them to the Job Seeker.

In one embodiment, wherein the skill selection is continuous (e.g., employing slider widgets), the Skills Deficiency module may calculate the difference vector, Δ, between the Job Seeker and job listing skill vectors as discussed before in an embodiment of the Skills Match module. The Skills Deficiency module may select those components of Δ with negative values (i.e., where the job listing skill vector component is higher than the corresponding Job Seeker skill vector component) and display them to the user. In another embodiment, the Skills Deficiency module may only display those skill components to the user that are more negative than a threshold amount. In another embodiment, the Skills Deficiency module may rank, order, or prioritize the displayed skills based on the magnitude of the negative skill component and/or the magnitude of the skill component in the job listing vector.

In one embodiment 900, wherein the skill selection for the job listing specifies a job listing subspace 920 rather than a job listing vector, the Skills Deficiency module may calculate the shortest vector 925 that, when added to the Job Seeker skills vector 915, yields a vector that intersects the job listing subspace. The components of this shortest vector may then be presented to the Job Seeker as indications of where and by how much the Seeker's skills need improving for the particular job listing. In an alternative embodiment, only those components greater than a particular threshold are displayed to the Job Seeker. In another embodiment, only those components indicative of a skill deficiency are displayed. In another embodiment, the skill components are ranked, ordered, or prioritized based on their relative magnitudes. In another embodiment, the Skills Deficiency module calculates other vectors that, when added to the Job Seeker skills vector, yield vectors that intersect the job listing subspace. For example, the Skills Deficiency module may calculate a vector that represents how much a single skill must be improved, keeping all other skills in the Job Seeker skill set fixed at their present values. In the example shown in FIG. 9, the vector labeled 930 represents the additional programming skill needed by the job seeker to intersect the job listing subspace keeping his/her mathematics skill fixed, while 935 represents the additional mathematics skill needed keeping his/her programming skill fixed. Other vectors may be calculated as needed by various particular applications of the present invention.

### Various Applications

The Platform provides a flexible system applicable to a wide variety of employment, educational, and skills assessment purposes. In one embodiment, the Platform supplies job listings to a Job Seeker that are targeted to the Seeker's specific experience, skills, and interest. By allowing the Job Seeker to specify personal skill levels and to provide interactive feedback through job listing ratings, the Platform is able to precisely tailor the listings supplied to the Job Seeker, thus heightening the possibility of connecting the Job Seeker to his or her ideal job listing.

In one embodiment, the Platform allows Job Seekers to submit queries to the Jobs and/or Job Listings databases based on a selection of skills chosen by the Job Seeker. A particular collection of selected skills forms an XML or SQL query that is used to search a database through the skills field associated with each database entry. In an embodiment in which the skills specification is binary, search results are ranked based on the number of matching skills between the Job Seeker and the job and/or job listing. The search results, comprised of jobs and/or job listings with skills matching the Job Seeker skill query, are then displayed to the Job Seeker. In another embodiment, search results displayed to the Job Seeker may be updated in real time in response to modifications of the skill set specified by the Job Seeker. For example, a split-screen user interface may be employed wherein a selection of skills are displayed in one section of the screen for the Job Seeker to select from, and jobs or job listings matching the Job Seeker's skills query are displayed in another part of the screen. Each time a Job Seeker modifies the skill set, the displayed jobs or job listings may be automatically updated. In an embodiment where the selection of skills is non-binary (i.e., where a Job Seeker specifies a skill vector with discrete or continuous component scores, such as via a radio button or slider widget), a skill set query may still be generated to search a job listings database. In one embodiment, a Job Seeker skill weight is assigned to each skill in the skill vector equal to the ratio of the skill component score for a given skill in the vector to the sum of skill component scores for all skills in the vector. Then, the Job Seeker skill weights for skills in the skill vector that match skills in a job listing may be summed to generate a search score for each job listing in the job listings database. Job listings may then be ranked based on this search score, and highest ranking job listings may be served to the Job Seeker in response to the skills query. In an embodiment where the job listing skills are also specified as skill vectors with discrete or continuous component skill scores, a job listing skill weight may be computed as the ratio of a skill component score for a given skill in the job listing skill vector to the sum of skill component scores for all skills in the job listing skill vector. A search score for the job listing may then be computed as the product of job listing skill weight and Job Seeker skill weight summed over all skills. This amounts to an inner product between the Job Seeker and job listing skill weight vectors, or equivalently to a projection of one skill weight vector onto the other.

In another embodiment, the Platform allows Employers to submit queries to the Job Seeker profile database based on a selection of skills chosen by the Employer in order to search for qualified employees to fill job openings. Weighting of skills and scoring/ranking of search results may proceed in a manner similar to the process described above for Job Seeker searches of the job listings database.

In one embodiment, the Platform allows Employers to view the skill profile of a Job Seeker, including a ranked list of skills. In another embodiment, the Platform allows Employers to view a ranked list of Job Seekers with respect to a specific skill or set of skills. For a set of skills, the ranking of Job Seekers may be based, for example, on a weighted sum of scores for skills in the set for each Job Seeker. In another embodiment, the Platform may provide a ranked list of jobs or job listings with respect to a skill or skill set. In another embodiment, the Platform may provide a ranked list of skills for a particular job or job listing.

In another embodiment, the Platform allows for detailed skills assessment, tracking, and profiling. Job Seekers may specify the skill levels that they possess or that they would expect their ideal jobs to require. The accumulated collection of skill specifications across Job Seekers may then be parsed and/or analyzed based on a variety of other factors associated with the Job Seeker profiles including most recent job title, target job title, experience level, education, geographic location, age, demographic criteria, and/or the like. Similarly, Employers may specify the skill levels that they expect or require for a particular job listing. The accumulated collection of job listing skill specifications may then be parsed and/or analyzed based on a variety of other factors associated with the job listings and/or Employers including job title, required experience, required education, company, geographic location, salary, vacation time, and/or the like. Therefore, in both the Job Seeker and Employer cases, the Platform allows a detailed analysis of skills across a spectrum of criteria.

In another embodiment, the Platform allows companies to assess skill levels of existing employees and to determine the most effective courses of action for employee skills development. A company may request employees to perform personal skills assessments, perhaps even anonymously. At the same time, managers may provide assessments of required skills for various positions within the company. The Platform may then compare employee and position skill assessments in a variety of different ways. For example, the Platform may directly compare an employee skill assessment with a position skill assessment for the position that the employee fills to determine the existence of skill gaps. In another example, the Platform may match employee skill profiles with position skill profiles to determine the positions that employees are most suited to fill. Such information may prove useful for promotions, in-house transfers, and/or the like. In yet another example, the Platform allows a company to profile skill levels within a group, division, branch location, or even across the entire company. Such a skill portfolio may be useful in diagnosing operational problems, assessing training effectiveness, or selecting courses of action for employee skill development.

In another embodiment, the Platform may be employed for assessing the effectiveness of training programs. On the one hand, the skills to be developed by the training program itself may be assessed by a manager, trainer, instructor, and/or the like. Then, individuals who complete the training program may self-assess the skills that they feel they have developed. A comparison of these two skill sets yields information about where a training program may be particularly effective, and where that program may be lacking in accomplishing it's intended purposes. In one embodiment, the Platform would find use in assessing vocational training programs. In another embodiment, the Platform would find use in assessing the effectiveness of a general education program intended to build a certain skill set in its students.

In another embodiment, the Platform allows Employers to specify a set of employer training skills for which they are willing to provide training and/or Job Seekers to specify job seeker training skills for which they are seeking training. In this embodiment, the skills specification UI shown in FIGS. 5 and 6 may include an additional row of ranking widgets allowing Job Seekers to rate skills that they would like to obtain, and in particular would like to receive training in, and allowing Employers to rate skills that they feel a Job Seeker may acquire in a particular job opening, and in particular are willing to provide training for. The Skills Match module may then consider the matching between employer training skills and job seeker training skills in its assessment of congruence between a Job Seeker and a job listing. In one embodiment, the matching between training skills may be treated on the same footing as other skills matches, while in an alternative embodiment, the training skills match impact on the Skills Match module may be different than other skills specified by the Employer and Job Seeker.

In another embodiment, the Platform may suggest jobs to a Job Seeker that he or she may not have initially considered. For example, the Platform may display job listings to a Job Seeker based solely on congruence between the Job Seeker skill set and job listing skill set, possibly presenting the Job Seeker with job listings that he/she may not have considered but that he/she may nevertheless be well-qualified for. In another embodiment, the Platform may compare Job Seeker skill sets with skill sets grouped by other job fields such as job title, company, location, salary/wage, job category, and/or the like to suggest a particular job field for the Job Seeker. For example, the Platform may inform a Job Seeker about a range of salaries/wages that may be suitable for him/her based on his/her skill set specification.

In another embodiment, the Platform may determine desirable jobs for which a Job Seeker is nearly qualified, and suggest skills that the Job Seeker may need to acquire in order to be fully qualified. When the Job Seeker skill set has been specified, the Platform may determine which job listing skill sets are close via the Skills Match module and/or Skills Deficiency module. Those nearby job listings that have desirable qualities (e.g., high salary/wage, convenient location, desirable company or job title, etc.) may then be selected and reported to the Job Seeker, along with an evaluation of the skill deficiencies that the Job Seeker should remedy in seeking those job opportunities as determined by the Skills Deficiency module.

In another embodiment, the Platform facilitates the filling of open positions for jobs or activities having no well-defined experience or educational requirements. The modern labor market is populated by increasingly unconventional job opportunities that require a particular set of skills but not necessarily any specific experience or educational background. An example would be in the field of management consulting, where employees are hired from a wide variety of different backgrounds, and a potential hire's specific background is examined mostly as a reflection of the skill assets that he/she may possess. Another example would be temporary work or assistantships, where a small, specific set of skills may be essential for the accomplishment of a very specific set of tasks, but no particular degree of experience or education is necessary. Additionally, there are numerous activities outside the employment market (e.g., volunteering, club activities, sports, recreation, etc.) where a participant's experience or education may be far less relevant than the skills he/she possesses. By enabling Employers and Job Seekers to connect via a skills approach, the Platform promotes the efficient appointment of suitable candidates for these types of jobs and activities.

Platform Controller

FIG. 10 of the present disclosure illustrates inventive aspects of a Platform controller 1001 in a block diagram. In this embodiment, the Platform controller 101 may serve to process, accept, retrieve, store, search, serve, submit, identify, transmit, instruct, generate, match, and/or update databases containing relevant job seeker information, employer information and/or job information, and/or related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the Platform controller 1001 may be connected to and/or communicate with entities such as, but not limited to: one or more users from user input devices 1011; peripheral devices 1012; and/or a communications network 1013.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Platform controller 1001 may be based on common computer systems that may comprise, but are not limited to, components such as: a computer systemization 1002 connected to memory 1029.

Computer Systemization

A computer systemization 1002 may comprise a clock 1030, central processing unit (CPU) 1003, a read only memory (ROM) 1006, a random access memory (RAM) 1005, and/or an interface bus 1007, and most frequently, although not necessarily, are all interconnected and/or communicating through a system bus 1004. Optionally, the computer systemization may be connected to an internal power source 1086. Optionally, a cryptographic processor 1026 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, Core and/or XScale; and/or the like processor(s). The CPU interacts with memory through signal passing through conductive conduits to execute stored program code according to conventional data processing techniques. Such signal passing facilitates communication within the Platform controller and beyond through various interfaces. Should processing requirements dictate a greater amount of speed, parallel, mainframe and/or super-computer architectures may similarly be employed. Alternatively, should deployment requirements dictate greater portability, smaller Personal Digital Assistants (PDAs) may be employed.

Power Source

The power source 1086 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 186 is connected to at least one of the interconnected subsequent components of the Platform controller thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the Platform controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Platform controller may be embodied as an embedded, dedicated, and/or monitor-less (i.e., headless) device, wherein access would be provided over a network interface connection.

Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the Platform controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 1029 may contain a collection of program and/or database modules and/or data such as, but not limited to: operating system module(s) 1015 (operating system); information server module(s) 1016 (information server); user interface module(s) 1017 (user interface); Web browser module(s) 1018 (Web browser); database(s) 1019; cryptographic server module(s) 1020 (cryptographic server); the Platform module(s) 1035; and/or the like (i.e., collectively a module collection). These modules may be stored and accessed from the storage devices and/or from storage devices accessible through an interface bus. Although non-conventional software modules such as those in the module collection, typically, are stored in a local storage device 1014, they may also be loaded and/or stored in memory such as: peripheral devices, RAM, remote storage facilities through a communications network, ROM, various forms of memory, and/or the like.

Operating System

The operating system module 1015 is executable program code facilitating the operation of the Platform controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the Platform controller to communicate with other entities through a communications network 1013. Various communication protocols may be used by the Platform controller as a subcarrier transport mechanism for interaction, such as, but not limited to: multicast, TCP/IP, UDP, unicast, and/or the like.

Information Server

An information server module 1016 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the Platform controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the Platform controller, operating systems, other program modules, user interfaces, Web browsers, and/or the like.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 1017 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 1018 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Platform enabled nodes. The combined application may be nugatory on systems employing standard Web browsers.

The Platform Database

The Platform database 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Platform database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Platform database is implemented as a data-structure, the use of the Platform database 1019 may be integrated into another component such as the Platform controller module 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 119a-c. A Job Seeker table 1019a includes Job Seeker profile information, with fields such as, but not limited to: job seeker name, job seeker ID number, mailing address, e-mail address, website, education, skill sets and/or skill ratings, work experience, awards and honors, salary preferences, job listing ratings, job title ratings, company ratings, resume, job listing search history, OC codes, and/or the like. A job listings table 1019b includes fields such as, but not limited to: job listing ID number, job title, company, category, description, keywords, skill sets and/or ratings, location, salary/wage, vacation time, expected tasks, education requirements, OC codes, job listing ratings, job title ratings, company ratings, and/or the like. A Jobs table 1019c includes fields such as, but not limited to: job ID number, job titles, tasks and/or work activities, knowledge expectations, skill sets, education expectations, salary/wage, job category, description, related occupations, OC codes, and/or the like. These and/or other tables may support and/or track multiple entity accounts on the Platform.

In one embodiment, the Platform database may interact with other database systems. For example, employing a distributed database system, queries and data access by Platform modules may treat the combination of the Platform database and a third party jobs database as a single database entity.

In one embodiment, user programs may contain various user interface primitives, which may serve to update the Platform. Also, various accounts may require custom database tables depending upon the environments and the types of entities the Platform may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-c. The Platform may be configured to keep track of various settings, inputs, and parameters via database controllers.

The Platform database may communicate to and/or with other components in a component collection, including itself, and/or facilities of the like. Most frequently, the Platform database communicates with the Platform controller module, other program components, and/or the like. The database may contain, retain, and provide information regarding other nodes and data.

Platform Controller Module

The Platform controller module 1035 is stored program code that is executed by the CPU. The Platform controller module affects accessing, obtaining and the provision of a Platform, and/or the like across various communications networks. The Platform enables Job Seekers and Employers to easily identify, connect, and coordinate with one another.

The Platform controller module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. The Platform controller module may communicate to and/or with other modules in a module collection, including itself, and/or facilities of the like. Most frequently, the Platform controller module communicates with the Platform library, operating systems, other program modules, and/or the like. The Platform controller module may contain, communicate, generate, obtain, and/or provide program module, system, user, and/or data communications, requests, and/or responses.

Distributed Platform

The structure and/or operation of any of the Platform controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the Platform controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A method of searching for jobs, comprising:
entering a job seeker profile information;
receiving job listings based on the entered job seeker profile information;
rating the received job listings based on a set of criteria;
receiving job listings based on the job listing ratings and the job seeker profile information; and
displaying the received job listings.

2. A method of specifying skills, comprising:
specifying a job title;
converting the job title into an associated occupational classification code;
querying a database based on the occupational classification code;
extracting a plurality of skills associated with the occupational classification code from the database;
receiving a rating of each skill of the plurality of skills; and
updating a profile with the ratings.

3. The method of claim 2, wherein the rating of each skill of the plurality of skills is binary.

4. The method of claim 2, wherein the rating of each skill of the plurality of skills is quasi-continuous.

5. The method of claim 2, wherein the profile is associated with a job listing.

6. The method of claim 2, wherein the profile is associated with a Job Seeker.

7. The method of claim 2, wherein the rating of each skill of the plurality of skills specifies a job listing desired skill level.

8. The method of claim 2, wherein the rating of each skill of the plurality of skills specifies a Job Seeker skill level.

9. A method, comprising:
querying a Job Seeker profile to extract a Job Seeker rated skill set;
querying a job listing profile to extract a job listing rated skill set;
comparing the Job Seeker rated skill set with the job listing rated skill set;
computing a skill deficiency profile based on the comparison; and
presenting the skill deficiency profile for display.

10. The method of claim 9, wherein comparing the Job Seeker rated skill set with the job listing rated skill set comprises:
determining the elements of the job listing rated skill set not contained in the Job Seeker rated skill set.

11. The method of claim 9, wherein computing a skill deficiency profile based on the comparison comprises:
comparing ratings of elements in the intersection of the Job Seeker rated skill set and the job listing rated skill set.

12. The method of claim 9, further comprising:
providing a recommendation for acquiring deficient skills based on the skill deficiency profile.

13. A method of selecting job listings from a database based on ratings, comprising:
determining a high rated keyword set comprised of a plurality of job listings having highest rated keywords;
determining a low rated keyword set comprised of a plurality of job listings having lowest rated keywords;
determining an overall keyword set comprised of elements in the high rated keyword set that are also not in the low rated keyword set;
removing elements of the overall keyword set having lowest rated job titles;

14. A method for connecting job listings and job seekers, comprising:
receiving a job seeker profile information;
analyzing the job seeker profile information based on a set of criteria;
storing the job seeker profile information in a job seeker profile;
receiving job requirement profile information;
analyzing the job requirement profile information based on a set of criteria;
storing the job requirement profile information in a job listings database;
querying the job listings database;
selecting a plurality of job listings from the job listings database based on the analysis of the job seeker profile information;
sending the selected job listings to a job seeker;
receiving a job seeker ratings of the job listings;
analyzing the job seeker ratings based on a set of criteria;
updating the job seeker profile with the job seeker ratings;
querying a job listings database;
selecting a plurality of job listings from the job listings database based on the job seeker ratings and the job seeker profile; and
sending the selected job listings to the job seeker.

15. The method of claim 14, wherein the analysis of the job seeker profile includes determining a most recent job title.

16. The method of claim 15, wherein the most recent job title is converted to an occupational classification code.

17. The method of claim 16, wherein the occupational classification code is used to select the plurality of job listings from the job listings database.

18. The method of claim 14, wherein the analysis of the job seeker profile includes determining a target job title.

19. The method of claim 18, wherein the target job title is converted to an occupational classification code.

20. The method of claim 19, wherein the occupational classification code is used to select the plurality of job listings from the job listings database.

21. The method of claim 14, wherein the job seeker profile information is comprised of a resume.

22. A method of connecting job listings and job seekers, comprising:
receiving a job seeker profile information, including a most recent job title;
storing the job seeker profile information in a job seeker profile;
converting the most recent job title into a plurality of most closely associated occupational classification codes;
receiving job requirement profile information;
analyzing the job requirement profile information based on a set of criteria;
storing the job requirement profile information in a job listings database;
querying the job listings database;
selecting a plurality of job listings from the job listings database for each of a plurality of occupational classification codes most closely associated with the job seeker's most recent job title;
sending the selected job listings to the job seeker;
receiving job seeker ratings of the selected job listings;
generating scores for the job listings, job titles, job companies, and job categories based on the job seeker ratings;
updating the job seeker's profile with the scores;
querying a job listings database;
selecting a plurality of job listings from the job listings database based on the scores in the job seeker's profile; and
sending the selected job listings to the job seeker.
selecting elements of the overall keyword set having highest rated job titles to yield an overall keyword and title set;
removing elements of the overall keyword and title set having lowest rated companies; and
selecting elements of the overall keyword and title set having highest rated companies.

23. A method of specifying skills, comprising:
specifying a job title;
converting the job title into an associated occupational classification code;
querying an in-memory index based on the occupational classification code;
extracting a plurality of skills associated with the occupational classification code from the in-memory index;
receiving a rating of each skill of the plurality of skills; and
updating a profile with the ratings.
